(19) United States
(12) Patent Application Publication
(10) Pub. No.: US 2019/0265937 A1
(43) Pub. Date: Aug. 29, 2019

(54) DISPLAY CALIBRATION DEVICE, DISPLAY CALIBRATION SYSTEM, AND DISPLAY DEVICE

(71) Applicant: Panasonic Liquid Crystal Display Co., Ltd., Hyogo (JP)

(72) Inventors: Yoshihisa KATO, Hyogo (JP); Junichi MARUYAMA, Hyogo (JP)

(21) Appl. No.: 16/285,877

(22) Filed: Feb. 26, 2019

(30) Foreign Application Priority Data
Feb. 28, 2018 (JP) 2018-034706

(51) Int. Cl. G06F 3/14; G06F 3/147; G06F 3/041; G09G 3/00

(52) U.S. Cl. CPC G06F 3/1415; G06F 3/1423; G09G 2320/0693; G06F 3/0418; G09G 3/006; G06F 3/147

(57) ABSTRACT

A display calibration device includes: an capture unit that captures an image displayed on the display device; a communicator that communicates with the display device; and a controller that controls the capture unit and the communicator. The controller includes: an calculating unit that generates correction data used to correct the display characteristic by performing arithmetic operation on the image captured by the capture unit; and a transmission unit that transmits the correction data generated by the calculating unit to the display device through the communicator, and the capture unit, the communicator, and the controller are integrated.

### CROSS-REFERENCE TO RELATED APPLICATION

This application claims priority from Japanese application JP 2018-034706, filed on Feb. 28, 2018. This Japanese application is incorporated herein by reference.

### TECHNICAL FIELD

The present disclosure relates to a display calibration device for calibrating a display characteristic of a display device, a display calibration system, a display calibration method, and a display device suitable for calibrating the display characteristic.

### BACKGROUND

In display devices such as a liquid crystal display (LCD), there is a variation in display characteristic. As used herein, the display characteristic is an image quality (luminance, color, and various kinds of unevenness) characteristic of each individual display device, and is a characteristic that can be adjusted by, for example, an input and output characteristic determined by a look-up table (hereinafter, also referred to as “LUT”). The display characteristic can be changed over time. For this reason, it is necessary to calibrate the display characteristic in each individual display device.

Conventionally, there has been proposed a display calibration system that calibrates the display characteristic of a display device (hereinafter, also simply referred to as “calibrating the display device”) (for example, see Unexamined Japanese Patent Publication No. 2010-81588). The display calibration system disclosed in Unexamined Japanese Patent Publication No. 2010-81588 includes a spectroscopic camera and an RGB camera, which capture a screen of the display device that is a calibration target, and a personal computer that analyzes images of the spectroscopic camera and the RGB camera to generate the LUT for image quality adjustment of the display device and updates image quality information about the display device using the generated LUT. This allows the calibration of the display device.

### SUMMARY

However, the display calibration system of Unexamined Japanese Patent Publication No. 2010-81588 is configured with a plurality of dedicated calibration devices, and a unique operation for each of the plurality of dedicated calibration devices is required to calibrate the display device. Thus, there is a problem in that high cost and many man-hours are required.

The present disclosure provides a display calibration device, a display calibration system, and a display calibration method capable of calibrating the display characteristic of the display device with lower cost and fewer man-hours than before, and a display device suitable for the calibration of the display characteristic.

A display calibration device according to the present disclosure, that calibrates a display characteristic of a display device, includes: an capture unit that captures an image displayed on the display device; a communicator that communicates with the display device; and a controller that controls the capture unit and the communicator. The controller includes: an calculating unit that generates correction data used to correct the display characteristic by performing arithmetic operation on the image captured by the capture unit; and a transmission unit that transmits the correction data generated by the calculating unit to the display device through the communicator, and the capture unit, the communicator, and the controller are integrated.

A display calibration system according to the present disclosure, includes: a display device; and the display calibration device having above feature that calibrates a display characteristic of the display device.

A display device according to the present disclosure includes: a communicator that communicates with the display calibration device having above feature; a video signal generator that acquires an image transmitted from the display calibration device through the communicator and generates a video signal indicating the acquired image; a video signal processor that includes a storage that obtains correction data transmitted from the display calibration device through the communicator and stores the correction data, the video signal processor correcting the video signal generated by the video signal generator using the correction data stored in the storage; and a display panel that displays the video signal corrected by the video signal processor.

A display calibration method according to the present disclosure for calibrating a display characteristic of a display device is provided, wherein the display characteristic of the display device is calibrated using the display calibration device having above feature.

In the display calibration method may further includes: a first display step of causing a display device to display an image without performing correction using correction data held in the display device; a calibration step of calibrating a display characteristic of the display device using a display calibration device while the image is displayed on the display device by the first display step, transferring correction data obtained by the calibration to the display device, and writing the correction data in the display device; and a second display step of causing the display device to correct a video signal using the written correction data, and displaying the corrected video signal.

### BRIEF DESCRIPTION OF THE DRAWINGS

FIG. 1 is a configuration diagram illustrating a display calibration system according to an exemplary embodiment;

FIG. 2 is a block diagram illustrating a configuration of a display device in FIG. 1;

FIG. 3 is a block diagram illustrating a configuration of a display calibration device in FIG. 1;

FIG. 4 is a sequence diagram illustrating basic operation of the display calibration system in FIG. 1;

FIG. 5 is a view illustrating a function of a foreign matter detector of the display calibration device in FIG. 3;

FIG. 6 is a flowchart illustrating a luminance unevenness calibration procedure using an image captured from a plurality of viewpoints by the display calibration device in FIG. 1;

FIG. 7A is a view illustrating a display example when the image displayed on the display device in FIG. 1 is viewed from the plurality of viewpoints;

FIG. 7B is a view illustrating an example of a graphical user interface by an imaging controller of the display calibration device in FIG. 3;

FIG. 8 is a view illustrating a processing flow of a method for calibrating luminance unevenness by dividing luminance unevenness into a permanent component and a temporal component by the display calibration device in FIG. 1;

FIG. 9A is an external view illustrating an example of a calibration jig for calibrating luminance of an capture unit of the display calibration device in FIG. 3;

FIG. 9B is an external view illustrating another example of the calibration jig for calibrating the luminance of the capture unit of the display calibration device in FIG. 3; and

FIG. 9C is a view illustrating a system configuration in which a calibrated camera or a calibrated luminance meter is used as a calibration jig for calibrating the luminance or the luminance unevenness of the capture unit of the display calibration device in FIG. 3.

### DETAILED DESCRIPTION

The following describes an exemplary embodiment of the present disclosure. The embodiment described below is merely one specific example of the present disclosure. The numerical values, shapes, materials, elements, and arrangement and connection of the elements, etc. indicated in the following embodiment are given merely by way of illustration and are not intended to limit the present disclosure. Therefore, among elements in the following embodiment, those not recited in any one of the independent claims defining the broadest inventive concept of the present disclosure are described as optional elements.

Note that the figures are schematic illustrations and are not necessarily precise depictions. Accordingly, the figures are not necessarily to scale. Moreover, in the figures, elements that are essentially the same share like reference signs. Accordingly, duplicate description is omitted or simplified.

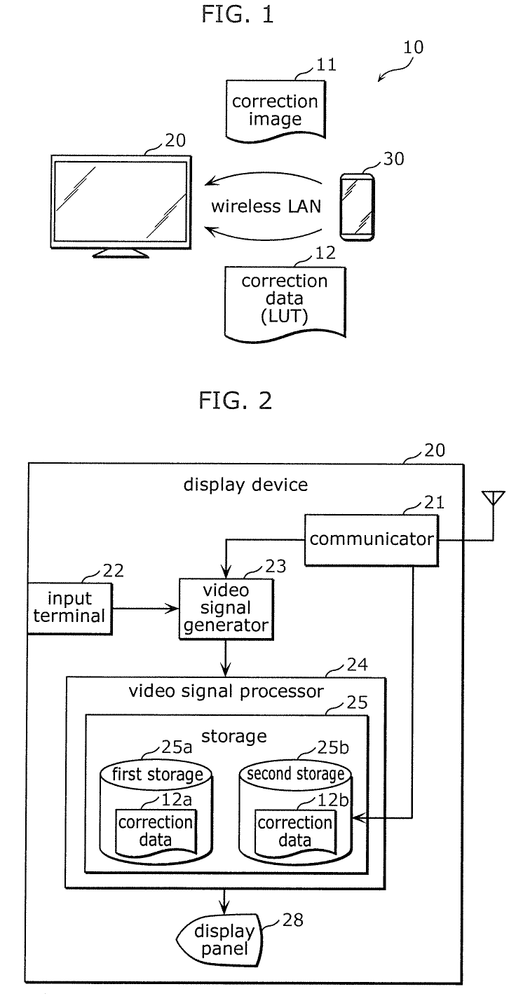

FIG. 1 is a configuration diagram illustrating display calibration system 10 according to an exemplary embodiment. As illustrated in FIG. 1, display calibration system 10 is configured with display device 20 and display calibration device 30.

Display device 20 is a display, such as an LCD and an organic electroluminescence (EL) display, which is a calibration target. The type of display device 20 is not limited to monochrome, gray scale, color, or the like.

Display calibration device 30 is a device that calibrates a display characteristic of display device 20. For example, display calibration device 30 is a portable information terminal, such as a smartphone and a tablet terminal, in which a camera is incorporated. In the exemplary embodiment, as illustrated in FIG. 1, display calibration device 30 transmits image for correction 11 to display device 20 by wireless communication such as wireless LAN to cause display device 20 to display image for correction 11, captures displayed image for correction 11 to generate correction data 12 that is the LUT used to correct the display characteristic of display device 20, and transmits generated correction data 12 to display device 20 by wireless communication to update the correction data of display device 20.

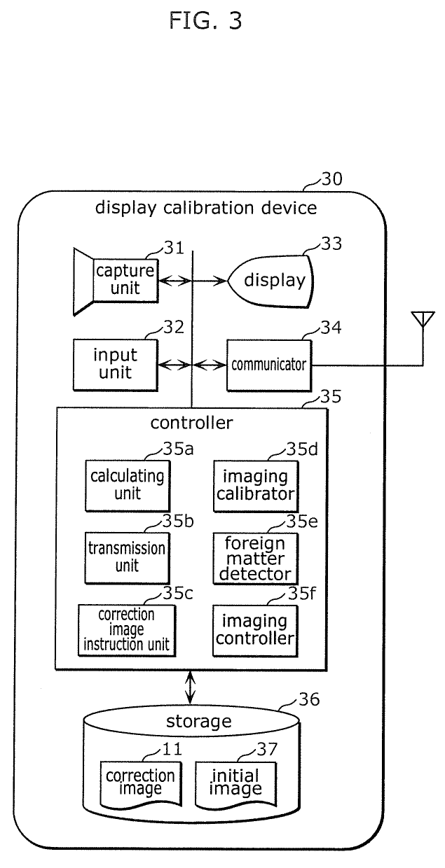

FIG. 2 is a block diagram illustrating a configuration of display device 20 in FIG. 1. As illustrated in FIG. 2, display device 20 includes communicator 21, input terminal 22, video signal generator 23, video signal processor 24, and display panel 28.

Communicator 21 is a communication adapter that communicates with an external device including display calibration device 30. For example, communicator 21 is a communication adapter for Bluetooth (registered trademark) or wireless LAN.

Input terminal 22 is a terminal that receives a video signal. For example, input terminal 22 is a VGA terminal, a DVI terminal, or an HDMI (registered trademark) terminal.

Video signal generator 23 is a circuit that converts a video or an image input from the communicator 21 into a video signal, or relays the video signal input from input terminal 22, thereby generating the video signal to output the video signal to video signal processor 24. For example, video signal generator 23 is a graphics processor.

Video signal processor 24 includes storage 25 that acquires and holds correction data 12 and the like, which are the LUT transmitted from display calibration device 30, through communicator 21. Video signal processor 24 corrects the video signal input from video signal generator 23 using pieces of correction data 12a and 12b held in storage 25, and outputs the corrected video signal to display panel 28. The pieces of correction data 12a and 12b are a set of coefficients by which each gradation value of the input signal is multiplied to convert the gradation value into an output signal. For example, the pieces of correction data 12a and 12b are data indicating a gamma curve. The pieces of correction data 12a and 12b may be data indicating an input and output characteristic independent of a pixel position (or a pixel block) of the display panel, data indicating a spatial luminance characteristic (that is, “luminance unevenness”) depending on the pixel position (or the pixel block) of the display panel, or both of them.

At this point, for example, storage 25 is a nonvolatile memory, and has a storage capacity in which at least two pieces of correction data 12a and 12b indicating different corrections are stored. More specifically, storage 25 includes first storage 25a that stores previously-provided correction data 12a (that is, an initial value at time of shipment from a factory) and a second storage 25b that stores correction data 12b (that is, correction data after the shipment from the factory) transmitted from display calibration device 30. Video signal processor 24 corrects the video signal input from video signal generator 23 using the correction data obtained by multiplying correction data 12a held in first storage 25a by correction data 12b held in second storage 25b, and outputs the corrected video signal to display panel 28.

Based on an instruction from a user or the like, video signal processor 24 can directly output the video signal to display panel 28 without correcting the video signal input from video signal generator 23 using the pieces of correction data 12a and 12b held in storage 25.

Display panel 28 is a display panel that displays the video signal input from video signal processor 24, and includes a timing controller (TCON), a data signal line driver, an address signal line driver, and a liquid crystal panel.

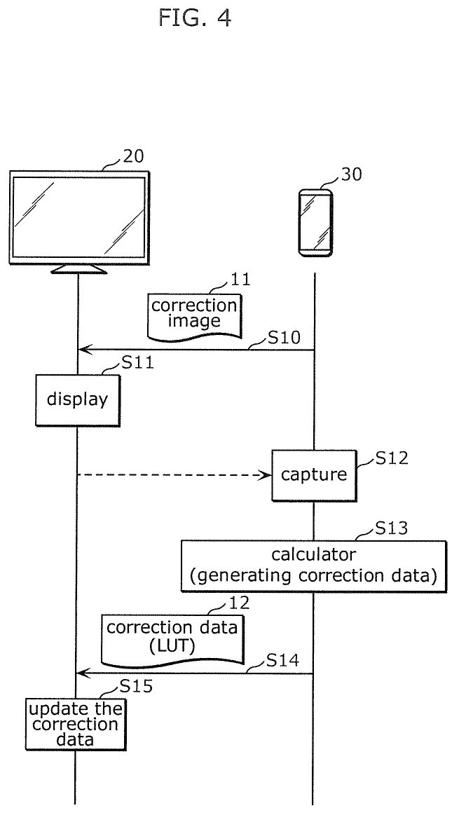

FIG. 3 is a block diagram illustrating a configuration of display calibration device 30 in FIG. 1. As illustrated in FIG. 3, display calibration device 30 includes capture unit 31, input unit 32, display 33, communicator 34, controller 35, and storage 36. As described above, display calibration device 30 is the portable information terminal such as a smartphone and a tablet terminal. Thus, capture unit 31, input unit 32, display 33, communicator 34, controller 35, and storage 36 are integrated and accommodated in one small portable casing.

In the exemplary embodiment, capture unit 31 is a camera that is used to capture an image for correction or an image for calibration displayed on display device 20. For example, capture unit 31 is a color CCD or a CMOS image sensor incorporated in the portable information terminal. The image for correction is an image used to calibrate display device 20, and the image for calibration is an image used to calibrate capture unit 31 of display calibration device 30.

Input unit 32 is an input device, such as a touch panel and a button, which receives the instruction from the user.

Display 33 is a display such as an LCD.

Communicator 34 is a communication adapter that communicates with an external device including display device 20. For example, communicator 34 may be a communication adapter for Bluetooth (registered trademark) or wireless LAN or a group of different kinds of communication adapters.

Controller 35 is a processor that exerts various functions as display calibration device 30 by controlling capture unit 31, input unit 32, display 33, communicator 34, and storage 36. Specifically, controller 35 is a control circuit including a memory in which a program such as an application is stored, a processor that executes the program, and various input and output ports, and controller 35 includes calculating unit 35a, transmission unit 35b, correction image instruction unit 35c, imaging calibrator 35d, foreign matter detector 35e, and imaging controller 35f as a functional component exerted by executing the program using the processor.

Calculating unit 35a performs arithmetic operation on the image for correction captured by capture unit 31, thereby generating correction data 12 that is the LUT used to correct the display characteristic of display device 20. For example, image for correction 11 is an image in which all pixels have an identical pixel value. Specifically, as luminance calibration, calculating unit 35a performs the arithmetic operation on the luminance at at least one of representative points of the image for correction captured by capture unit 31 using a reference value of the luminance at the representative point, thereby generating correction data 12. At this point, calculating unit 35a performs the arithmetic operation on the luminance at at least one of representative points of the image for correction captured by capture unit 31 with the luminance corresponding to the representative point of image for correction 11 stored in storage 36 as the reference value, thereby generating the correction data. As the calibration of the luminance unevenness, calculating unit 35a performs the arithmetic operation to calculate the spatial luminance unevenness on the image for correction captured by capture unit 31, thereby generating correction data 12.

Transmission unit 35b transmits correction data 12 generated by calculating unit 35a to display device 20 through communicator 34. This allows update of the correction data held in display device 20 that receives the correction data 12.

Correction image instruction unit 35c transmits the image for correction 11 stored in storage 36 to display device 20 through communicator 34, and causes display device 20 to display image for correction 11.

Imaging calibrator 35d acquires data from an accessory through communicator 34, and calibrates capture unit 31 using the acquired data. The accessory is a calibrated camera that captures the image displayed on display device 20 or a calibrated luminance meter that measures the luminance. After capture unit 31 captures the image for calibration while the image for calibration used to calibrate capture unit 31 is displayed on display device 20, imaging calibrator 35d calibrates a geometric characteristic of capture unit 31 using the image for calibration captured by capture unit 31.

After display device 20 switches and displays a plurality of different images and capture unit 31 captures the plurality of different images, foreign matter detector 35e determines, from the plurality of images captured by capture unit 31, whether an identical display object exists at a common position in the plurality of images, thereby detecting a foreign matter adhered to a screen of display device 20 or capture unit 31 to inform a user about existence of the foreign matter.

Imaging controller 35f controls capture unit 31 such that an image displayed on display device 20 is captured from a plurality of viewpoints. At this point, calculating unit 35a synthesizes a plurality of images captured from the plurality of viewpoints by capture unit 31, and performs the arithmetic operation on the image obtained by the synthesization, thereby generating the correction data.

Not only storage 36 functions as a correction image storage that stores image for correction 11 and an initial image storage that stores initial image 37 illustrating a spatial distribution of the luminance of display device 20, but also storage 36 is a memory that stores various images and various pieces of data. For example, storage 36 is a nonvolatile memory.

Operation of display calibration system 10 of the exemplary embodiment having the above configuration will be described below.

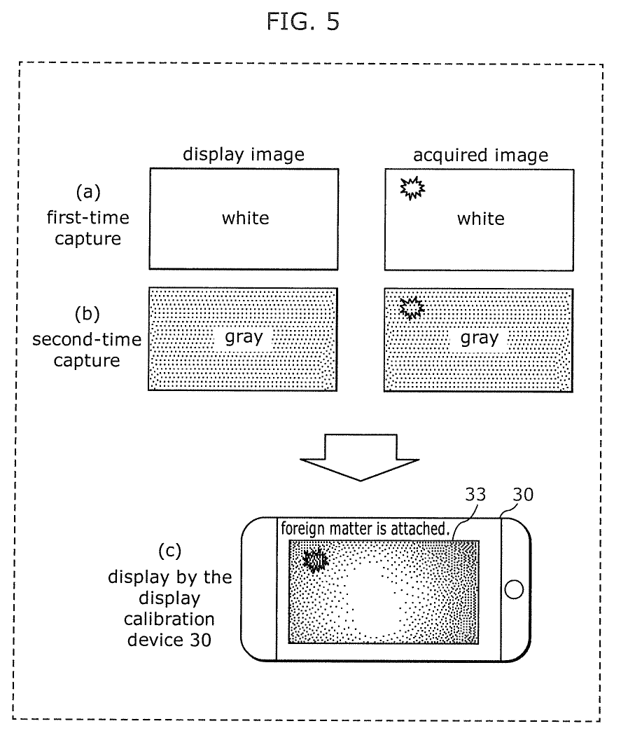

FIG. 4 is a sequence diagram illustrating basic operation (that is, a method for calibrating display device 20) of display calibration system 10 in FIG. 1. At this point, operation procedures and communication exchanges of display device 20 and display calibration device 30 are illustrated in FIG. 4.

In display calibration device 30, according to the instruction from the user through input unit 32, correction image instruction unit 35c of controller 35 reads image for correction 11 from storage 36, and transmits read image for correction 11 to display device 20 through communicator 34 (S10). Incidentally, a plurality of images for correction 11 corresponding to various purposes or accuracy are stored in storage 36, and correction image instruction unit 35c may read image for correction 11 selected from the plurality of images for correction 11 from storage 36 according to the user's instruction from the input unit 32, and transmit selected image for correction 11 to display device 20.

Subsequently, in display device 20, image for correction 11 received through communicator 21 is converted into the video signal by video signal generator 23, and the converted video signal is transmitted to video signal processor 24. In video signal processor 24, the input video signal is corrected using correction data 12a (that is, the initial value at the time of the shipment from the factory) stored in storage 25, transmitted to display panel 28, and displayed (S11). In the correction, typically, the correction is performed using correction data 12a (that is, the initial value at the time of the shipment from the factory) stored in the storage 25. Alternatively, the correction may be performed using correction data obtained by multiplying correction data 12a held in first storage 25a by the correction data 12b (that is, correction data after factory shipment) held in second storage 25b. Alternatively, the video signal input from video signal generator 23 may be output without performing the correction, namely, the video signal may directly be output to display panel 28 (first display step).

Subsequently, in display calibration device 30, capture unit 31 captures image for correction 11 displayed on display device 20 (S12). When the luminance calibration is performed, the processing steps (S10 to S12) of transmitting the plurality of images for correction 11 with different luminances from display calibration device 30 to display device 20, displaying the plurality of images for correction 11 on display device 20, capturing image for correction 11 displayed on display device 20 and holding image for correction 11 using display calibration device 30 (temporarily storing image for correction 11 in storage 36) are repeated with respect to the plurality of images for correction 11.

Subsequently, calculating unit 35a of display calibration device 30 performs the arithmetic operation on the image for correction captured by capture unit 31, thereby generating correction data 12 that is the LUT used to correct the display characteristic of display device 20 (S13). Specifically, as luminance calibration, calculating unit 35a performs the arithmetic operation (for example, division) on the luminance at at least one of representative points of the image for correction captured by capture unit 31 using a reference value of the luminance at the representative point, thereby generating correction data 12 by the luminance calibration. At this point, calculating unit 35a performs the arithmetic operation on the luminance at at least one of representative points of the image for correction captured by capture unit 31 using as the reference value the luminance corresponding to the representative point of image for correction 11 stored in storage 36, thereby generating correction data 12 by the luminance calibration.

When the plurality of images for correction 11 with different luminances are stored in storage 36, calculating unit 35a calculates a correction coefficient in each of the plurality of different luminances. That is, calculating unit 35a reads one image for correction 11 from storage 36, and divides the luminance of the reference value by the luminance at the representative point of read image for correction 11, thereby calculating the correction coefficient corresponding to one luminance (that is, a gradation value). The processing is repeated for the plurality of images for correction 11 (that is, a plurality of gradation values) stored in storage 36. Calculating unit 35a calculates the correction coefficients for all the luminances (that is, gradation values) by complementing the plurality of obtained correction coefficients, and generates a group of the calculated correction coefficients as correction data 12 used to correct the luminance.

Alternatively, as the calibration of the luminance unevenness, calculating unit 35a calculates the spatial luminance unevenness of the image for correction captured by capture unit 31, thereby generating correction data 12 used to correct the luminance unevenness. For example, an average value for pixel values (or pixel blocks) of the captured image for correction is calculated, and the group of the correction coefficients obtained by dividing the calculated average value by each pixel value (or the average pixel value of the pixel blocks) is calculated as the correction data used to correct the luminance unevenness. Which one of the luminance calibration, the calibration of the luminance unevenness, and both of them is performed depends on a previous setting of the user through input unit 32.

Transmission unit 35b of display calibration device 30 transmits correction data 12 generated by calculating unit 35a to display device 20 through communicator 34 (S14).

In display device 20, correction data 12 transmitted from display calibration device 30 is received by communicator 21, and overwritten and stored in second storage 25b by video signal processor 24 (calibration step S15). Consequently, correction data 12b of second storage 25b is updated.

In the case where image for correction 11 is displayed by outputting the video signal input from video signal generator 23 to display panel 28 without correcting the video signal using video signal processor 24 in step S11 (first display step), in display device 20, correction data 12 transmitted from display calibration device 30 may be overwritten and stored in first storage 25a by video signal processor 24.

After the calibration is completed, in display device 20, video signal processor 24 corrects the video signal input from video signal generator 23 using the correction data obtained by multiplying correction data 12a held in first storage 25a by correction data 12b held in second storage 25b, and outputs the corrected video signal to display panel 28 (second display step). In this way, display device 20 performs the display reflecting the luminance calibration, the calibration of luminance unevenness, or both of them by display calibration device 30.

As described above, display calibration device 30 of the exemplary embodiment is a device that calibrates the display characteristic of display device 20, and includes capture unit 31 that captures the image displayed on display device 20, communicator 34 that communicates with display device 20, and controller 35 that controls capture unit 31 and communicator 34. Controller 35 includes calculating unit 35a that generates the correction data used to correct the display characteristic by performing the arithmetic operation on the image captured by capture unit 31 and transmission unit 35b that transmits the correction data generated by calculating unit 35a to display device 20 through communicator 34. At least capture unit 31, communicator 34, and controller 35 are integrated.

Consequently, capture unit 31, communicator 34, and controller 35 are integrated in display calibration device 30, and display calibration device 30 can be implemented as a portable information terminal such as a smartphone. As a result, display calibration device 30 is constructed at a lower cost as compared with the case where the calibration device is constructed with the calibration dedicated instrument as in the conventional case. Additionally, the calibration can be performed by unified operation without connecting or separately handling individual calibration dedicated instrument. Thus, the display calibration device 30 that can calibrate the display characteristic of display device 20 at lower cost and fewer man-hours than before is achieved.

At this point, for example, display calibration device 30 is the portable information terminal.

Because display calibration device 30 is implemented with the portable information terminal such as a widely-spread smartphone, display calibration device 30 can be achieved only by installing an application with no use of special hardware.

Calculating unit 35a generates the correction data by performing the arithmetic operation on the luminance at at least one of the representative points of the image captured by capture unit 31 using the reference value of the luminance at the representative point.

Consequently, the luminance calibration is performed by display calibration device 30.

Calculating unit 35a generates the correction data by performing the arithmetic operation to calculate the spatial luminance unevenness on the image captured by capture unit 31.

Consequently, the calibration of the luminance unevenness is performed by display calibration device 30.

Display calibration device 30 further includes storage 36 as the correction image storage in which image for correction 11 is stored, controller 35 further includes correction image instruction unit 35c that transmits image for correction 11 stored in the correction image storage to display device 20 through communicator 34 and causes display device 20 to display image for correction 11, and capture unit 31 captures image for correction 11 displayed on display device 20.

As a result, the display characteristic can be calibrated after the image for correction held in display calibration device 30 is displayed on display device 20, so that any image for correction can be selected on the side of display calibration device 30 as the image for correction used in the calibration.

Calculating unit 35a generates the correction data by performing the arithmetic operation on the luminance at at least one of representative points of the image for correction captured by capture unit 31 using as the reference value the luminance corresponding to the representative point of image for correction 11 stored in storage 36.

Consequently, the luminance calibration is performed based on the image for correction held in display calibration device 30, so that the luminance calibration can be performed with high accuracy using various images for correction.

Display calibration system 10 of the exemplary embodiment includes display device 20 and display calibration device 30 that calibrates the display characteristic of display device 20.

Consequently, the display calibration system 10 that can calibrate the display characteristic of display device 20 at lower cost and fewer man-hours than before is achieved because the portable information terminal such as a smartphone can be used as display calibration device 30.

Display device 20 of the exemplary embodiment includes communicator 21 that communicates with display calibration device 30, video signal generator 23 that acquires the image transmitted from display calibration device 30 through communicator 21 and generates the video signal indicating the acquired image, video signal processor 24 that includes storage 25, which acquires the correction data transmitted from display calibration device 30 through communicator 21 and stores the correction data, and corrects the video signal generated by video signal generator 23 using the correction data stored in storage 25, and display panel 28 that displays the video signal corrected by video signal processor 24.

Consequently, display device 20 in which the display characteristic is calibrated at lower cost and fewer man-hour is achieved with display calibration device 30 that is the portable information terminal such as a smartphone.

Storage 25 of display device 20 has a storage capacity in which at least two pieces of correction data 12a and 12b indicating different corrections are stored.

Consequently, even if the state is to be returned to the state before the calibration for some reason after the calibration, restoration can be performed using one of the two pieces of correction data 12a and 12b for backup use or the like, and highly-functional display device 20 is achieved.

Storage 25 of display device 20 includes first storage 25a in which previously-provided correction data 12a is stored and second storage 25b in which correction data 12b transmitted from display calibration device 30 is stored.

Consequently, first storage 25a is used to store the initial value and second storage 25b is used for the update, whereby the display characteristic can always be restored to the initial state, and display device 20 having excellent convenience is achieved. As an example, first storage 25a may be configured with a read-only and non-rewritable read only memory (ROM), and the second storage 25b may be configured with a rewritable random access memory (RAM).

Video signal processor 24 outputs the video signal generated by the video signal generator 23 without correcting the video signal using the pieces of correction data 12a and 12b stored in storage 25, and the display panel 28 displays the video signal that is output from video signal processor 24 without performing the correction.

This allows the display of the video signal that does not reflect the correction data, so that display device 20 can be calibrated after the image is displayed with the original display characteristic of display device 20. Thus, the correction data that can directly correct the original display characteristic of display device 20 is generated without being affected by the preceding correction data.

The method for calibrating display device 20 of the exemplary embodiment is a method for calibrating the display characteristic of display device 20 using display calibration device 30.

Consequently, the display characteristic of display device 20 can be calibrated at lower cost and fewer man-hours than before because the portable information terminal such as a smartphone can be used as display calibration device 30.

The method for calibrating display device 20 includes the first display step (S11) and the second display step. In the first display step, display device 20 displays the image without performing the correction using the correction data held in display device 20. In the second display step, display calibration device 30 calibrates the display characteristic of display device 20 (S12, S13) while the image is displayed on display device 20 by the first display step (S11), display calibration device 30 transfers the correction data obtained by the calibration to display device 20 (S14), the correction data is written in display device 20 (S15), and display device 20 corrects the video signal using the written correction data and displays the corrected video signal.

Consequently, the display of the video signal that does not reflect the correction data allows display device 20 to be calibrated after the image is displayed with the original display characteristic of display device 20. Thus, the calibration in which the correction data that can directly correct the original display characteristic of display device 20 is generated without being affected by the preceding correction data can be performed.

Additional features of display calibration device 30 of the exemplary embodiment will be described below.

First, foreign matter detection will be described as one of the additional features of display calibration device 30.

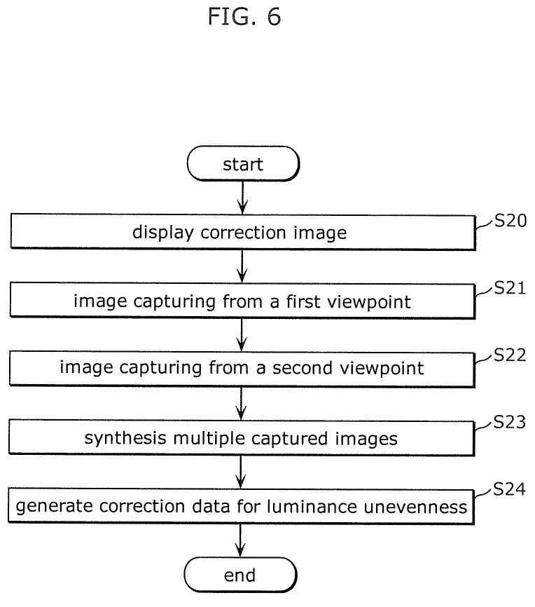

FIG. 5 is a view illustrating a function of foreign matter detector 35e of display calibration device 30 in FIG. 3. A procedure for foreign matter detection ((a) first-time imaging, (b) second-time imaging, (c) display by display calibration device 30) is illustrated in FIG. 5.

First, as the “first-time imaging” step, capture unit 31 of display calibration device 30 captures a first image (in this case, a white image) while the first image is displayed on display device 20, and the obtained first image is stored in storage 36 (a part (a) of FIG. 5).

Subsequently, as the “second-time imaging” step, capture unit 31 of display calibration device 30 captures a second image (in this case, a gray image) while the second image is displayed on display device 20, and the obtained second image is stored in storage 36 (a part (b) of FIG. 5).

The image capturing of different images as described above is not limited to twice, but may be any number of three or more times.

Finally, as the step of performing the “display by the display calibration device 30”, foreign matter detector 35e determines, from the plurality of images (in this case, the first and second images stored in storage 36) captured by capture unit 31, whether the identical display object exists at the common position in these images, thereby detecting that the foreign matter adheres to the screen of display device 20 or capture unit 31 to present the adhesion of the foreign matter to the user (a part (c) of FIG. 5).

Specifically, foreign matter detector 35e performs image processing such as outline extraction extracting regions having spatially different luminances on each of the plurality of images read from storage 36, and determines whether the luminance of the extracted region changes relatively in the plurality of images. As a result, a determination is made that the “luminance unevenness” is generated for the region where the luminance changes relatively. On the other hand, a determination is made that the “foreign matter” adheres for the region where the luminance does not relatively change, and the determination result is presented on display 33. Consequently, the user who views display 33 of display calibration device 30 can know that the foreign matter adheres to the screen of display device 20 or capture unit 31 in the case where the foreign matter adheres.

As described above, in the foreign matter detection, display device 20 switches and displays the plurality of different images, and capture unit 31 captures the plurality of images displayed on display device 20. Foreign matter detector 35e detects the adhesion of the foreign matter to the screen of display device 20 or capture unit 31 by determining, from the plurality of images captured by capture unit 31, whether the identical display object exists at the common position in the plurality of images.

Consequently, the adhesion of the foreign matter to the screen of display device 20 or capture unit 31 is detected, so that the high-accuracy calibration of the luminance unevenness is secured by removing the foreign matter in the case where the adhesion of the foreign matter is detected.

The calibration of the luminance unevenness using images captured from a plurality of viewpoints will be described below as a second additional feature of display calibration device 30.

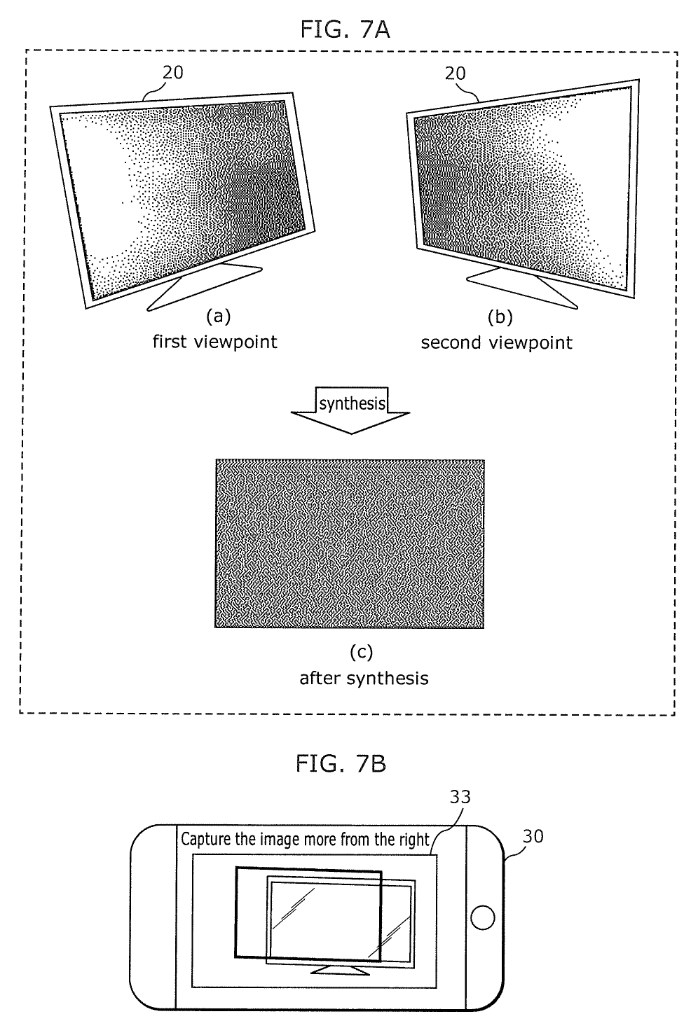

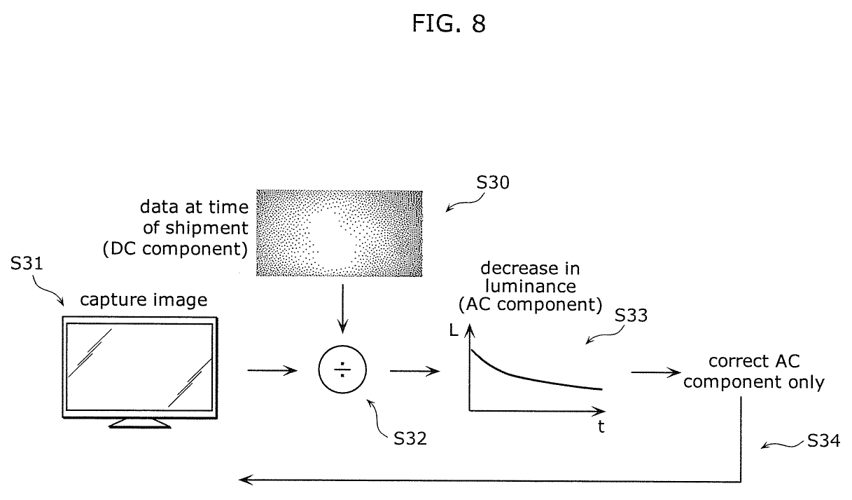

FIG. 6 is a flowchart illustrating a calibration procedure of the luminance unevenness using the images captured from the plurality of viewpoints by display calibration device 30 in FIG. 1. FIG. 7A is a view illustrating a display example when the image displayed on display device 20 in FIG. 1 is viewed from the plurality of viewpoints. FIG. 7B is a view illustrating an example of a graphical user interface by imaging controller 35f of display calibration device 30 in FIG. 3.

First, in display device 20, image for correction 11 in which all the pixels have the identical pixel value is displayed (S20 in FIG. 6).

Subsequently, display calibration device 30 performs the image capturing from a first viewpoint (S21 in FIG. 6, a part (a) of FIG. 7A). Specifically, as illustrated in FIG. 7B, imaging controller 35f displays an image on display 33, the image prompting the user to capture image for correction 11 displayed on display device 20 from the first viewpoint (for example, in obliquely left front of display device 20) among the plurality of viewpoints. More specifically, imaging controller 35f displays a guide indicating a frame of display panel 28 in the case where display device 20 is viewed from the first viewpoint, a moving image of a target object to be captured by capture unit 31, and a guidance message on display 33 of display calibration device 30 while displaying the guide, the moving image, and the guidance message at the same time. As used herein, the guidance message is, for example, “Capture the image from a direction in which the frame of the screen of the display device is matched with the guide”, “Capture the image more from the right”, and the like. The user performs the image capturing while matching the frame of the screen of display device 20 with the guide on display 33. Then, imaging controller 35f stores the image obtained by the image capturing in storage 36.

Subsequently, display calibration device 30 performs the image capturing from a second viewpoint (S22 in FIG. 6, a part (b) of FIG. 7A). Specifically, imaging controller 35f displays an image on display 33, the image prompting the user to capture image for correction 11 displayed on display device 20 from the second viewpoint (for example, in obliquely right front of display device 20) among the plurality of viewpoints. In this case, imaging controller 35f displays a guide illustrating the frame of display panel 28 in the case where display device 20 is viewed from the second viewpoint as the guide displayed on display 33 of display calibration device 30. The user performs the image capturing while matching the frame of the screen of display device 20 with the guide on display 33. Then, imaging controller 35f stores the image obtained by the image capturing in storage 36.

The image capturing from such different viewpoints is not limited to the image capturing from two directions, but the image may be captured from three or more directions.

When the images captured from the plurality of viewpoints under the guidance of imaging controller 35f using a graphical user interface are stored in storage 36, finally, calculating unit 35a generates the correction data using the images captured from the plurality of viewpoints (S23 to S24 in FIG. 6, a part (c) of FIG. 7A). Specifically, calculating unit 35a reads the images captured from the plurality of viewpoints from storage 36, adds (or averages) the pixel values at the identical pixel positions of the plurality of read images to synthesize the plurality of images (S23 in FIG. 6), and generates correction data 12 used to correct the luminance unevenness by performing the above arithmetic operation on the image obtained by the synthesis (S24 in FIG. 6, a part (c) of FIG. 7A).

In this way, in the calibration of the luminance unevenness using the plurality of images, imaging controller 35f controls capture unit 31 such that an image displayed on display device 20 is captured from the plurality of viewpoints. Calculating unit 35a synthesizes the plurality of images captured from the plurality of viewpoints by capture unit 31, and performs the arithmetic operation on the image obtained by the synthesization, thereby generating the correction data used to correct the luminance unevenness.

Consequently, the correction data is generated by synthesizing and using the plurality of images captured from the plurality of viewpoints, so that the luminance unevenness of display device 20 can be calibrated while the influence of noise such as moire, beat, and external light is prevented.

A method in which the luminance unevenness of display device 20 is calibrated while the luminance unevenness is divided into a permanent component and a temporal component will be described below as a third additional feature of display calibration device 30.

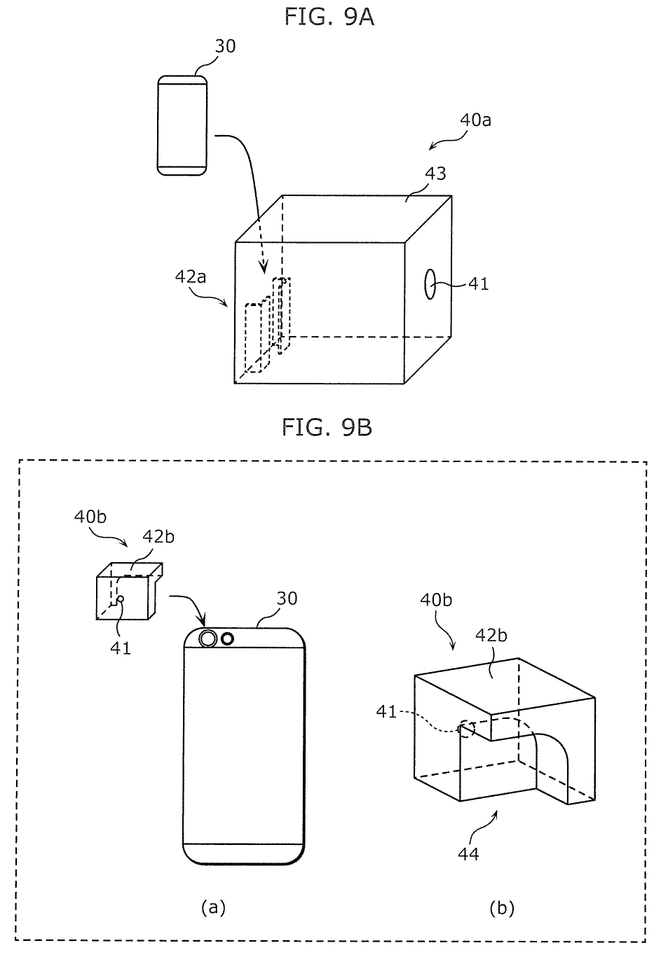

FIG. 8 is a view illustrating a processing flow of the method for calibrating the luminance unevenness by dividing the luminance unevenness into the permanent component and the temporal component by display calibration device 30 in FIG. 1.

First, initial image 37 illustrating the spatial distribution of the luminance (that is, the luminance unevenness) in the initial state of display device 20 (for example, at the time of the shipment from the factory) is stored in storage 36 of display calibration device 30 (S30). For example, the user who has purchased display device 20 causes display device 20 to display image for correction 11 used to calibrate the luminance unevenness at beginning of the use of display device 20, captures displayed image for correction 11 using capture unit 31 of display calibration device 30, and stores the captured image in storage 36 as initial image 37. Initial image 37 is information indicating the permanent component (a so-called DC component) relating to the luminance unevenness of display device 20.

When the time of calibrating the luminance unevenness of display device 20 arrives, image for correction 11 identical to that used to acquire the initial image is displayed on display device 20, and displayed image for correction 11 is captured by capture unit 31 of display calibration device 30 (S31).

In display calibration device 30, calculating unit 35a calculates the spatial luminance unevenness of the currently-captured image for correction based on initial image 37 stored in storage 36 (S32), generates correction data 12, and stores generated correction data 12 in storage 36 while correlating generated correction data 12 with generation timing. Specifically, the group of correction coefficients (or reciprocals of the correction coefficients) obtained by dividing the pixel value of the captured image for correction at the identical position by the pixel value of initial image 37 in units of pixels (or pixel blocks) is generated as correction data 12, and stored in storage 36 while correlated with the generation timing. Correction data 12 is information indicating the temporal component (a so-called AC component) relating to the luminance unevenness of display device 20.

For example, the calibration of the luminance unevenness (S31, S32) is repeated at regular intervals (S33). Consequently, the change in the display characteristic of display device 20 with time (in this case, the decrease in luminance) can be checked by causing display 33 to display the change in the display characteristic.

Correction data 12 obtained by the calibration of the luminance unevenness is transferred to display device 20 through communicator 34 by transmission unit 35b of display calibration device 30 (S34), and written in storage 25 of display device 20.

In this way, in the calibration of the luminance unevenness using initial image 37, initial image 37 illustrating the spatial distribution of the luminance of display device 20 is stored in storage 36 that is the initial image storage. Calculating unit 35a calculates the spatial luminance unevenness of the image captured by capture unit 31 based on initial image 37 stored in the initial image storage, thereby generating the correction data.

Consequently, the luminance unevenness is divided into the permanent component and the temporal component, the permanent component is accurately calibrated using the data of display device 20 at the time of shipment from the factory, the temporal component is easily calibrated by display calibration device 30 such as a smartphone, and the high-accurate calibration in which the fine luminance unevenness can be corrected is achieved as a whole.

A calibration jig for calibrating the luminance of capture unit 31 will be described below as a fourth additional feature of display calibration device 30.

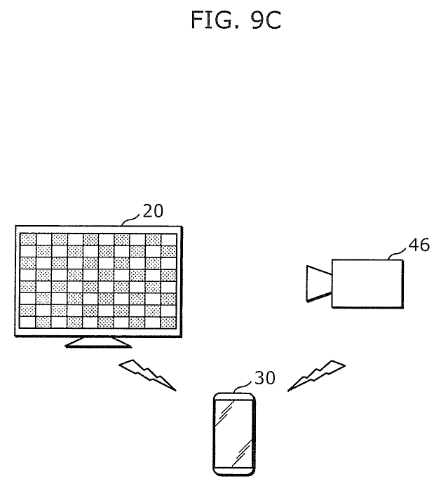

FIG. 9A is an external view illustrating an example (calibration jig 40a) of the calibration jig for calibrating the luminance of capture unit 31 of display calibration device 30 in FIG. 3.

Calibration jig 40a is configured with light source 41 having known luminance, positioning unit 42a that is a structure that positions capture unit 31 with respect to light source 41, and casing 43 in which light source 41 and positioning unit 42a are accommodated.

Casing 43 is a box body made of corrugated cardboard that is sealed so as to prevent light from entering the inside of the box body from the outside.

Light source 41 is attached to an inside surface of one surface of the casing 43 and emits light having the known (that is, constant) luminance toward an opposing inside surface. For example, light source 41 is configured with a battery, a constant-current circuit that outputs constant current with electric power as input, and an LED to which the current from the constant-current circuit is applied.

Positioning unit 42a is a positioning guide that fixes display calibration device 30 to the inside (the inside surface opposed to light source 41) of casing 43 such that the light emitted from light source 41 is incident on an incident port of capture unit 31 of display calibration device 30.

With this calibration jig 40a, an imaging characteristic of capture unit 31 of display calibration device 30 can be calibrated using light source 41 having the known luminance, and the calibration by display calibration device 30 is secured with high accuracy.

Because calibration jig 40a is provided with the positioning guide that fixes capture unit 31 to the inside of casing 43, a positional relationship between light source 41 and capture unit 31 is easily and certainly fixed, and the calibration work for capture unit 31 of display calibration device 30 becomes easy and accurate.

FIG. 9B is an external view illustrating another example (calibration jig 40b) of the calibration jig for calibrating the luminance of capture unit 31 of display calibration device 30 in FIG. 3.

Calibration jig 40b is configured with light source 41 having the known luminance and positioning unit 42b that is a structure that positions capture unit 31 with respect to light source 41.

Light source 41 is similar to light source 41 of calibration jig 40a, and is a light source that emits the light having the known (that is, constant) luminance. For example, light source 41 is configured with a battery, a constant-current circuit that outputs constant current with electric power as input, and an LED to which the current from the constant-current circuit is applied.

Positioning unit 42b is an attachment to which light source 41 is attached, and the attachment is detachably attached to capture unit 31. More specifically, positioning unit 42b is a box body to which light source 41 is attached, and includes recess 44 in which a corner portion of display calibration device 30 including capture unit 31 can be fitted. By fitting the corner portion of display calibration device 30 including capture unit 31 in recess 44 of positioning unit 42b, the light emitted from light source 41 can stably enter the incident port of capture unit 31.

As described above, calibration jig 40b includes light source 41 having the known luminance and positioning unit 42b that is the structure that positions capture unit 31 with respect to light source 41. Positioning unit 42b is an attachment that is detachably attached to capture unit 31.

Consequently, because calibration jig 40b includes the attachment that is detachably attached to capture unit 31, the positional relationship between light source 41 and capture unit 31 can easily and certainly be fixed only by attaching calibration jig 40b to capture unit 31, and the calibration work for capture unit 31 of display calibration device 30 can simply be performed. Thus, an expensive environment such as a dark room as in the conventional case becomes unnecessary.

FIG. 9C is a view illustrating a system configuration in which a calibrated camera or a calibrated luminance meter (in this case, calibrated luminance meter 46) is used as the calibration jig for calibrating the luminance or the luminance unevenness of capture unit 31 of the display calibration device 30 in FIG. 3.

Luminance meter 46 is an accessory of display calibration device 30, is a calibrated measurement device that measures the luminance of the image for calibration displayed on display device 20, and has a function of communicating with display calibration device 30. Luminance meter 46 is not limited to a dedicated measuring device, but may be a calibrated camera. The image for calibration displayed on display device 20 may be identical to image for correction 11 used to calibrate display device 20, or may be a dedicated image used to calibrate capture unit 31. For example, the image for calibration is an image in which all the pixels have the identical pixel value.

In display calibration device 30, similarly to luminance meter 46, capture unit 31 captures the image for calibration displayed on display device 20. Imaging calibrator 35d acquires data indicating the luminance measured by luminance meter 46 from luminance meter 46 through communicator 34, and calibrates capture unit 31 using the acquired data. Specifically, imaging calibrator 35d calculates the average luminance using at least one representative point of the image for calibration captured by capture unit 31, and performs the luminance calibration or color calibration such that the calculated average luminance becomes the luminance indicated by the data acquired from luminance meter 46.

As described above, display calibration device 30 includes the calibrated camera that captures the image displayed on display device 20 or the calibrated luminance meter that measures the luminance as the accessory. Controller 35 of display calibration device 30 includes imaging calibrator 35d that acquires the data from the accessory via the communicator 34 and calibrates the luminance of capture unit 31 using the acquired data.

Consequently, the luminance calibration can be performed on capture unit 31 of display calibration device 30 using calibrated luminance meter 46, and the luminance calibration for display device 20 by display calibration device 30 is secured with high accuracy.

Imaging calibrator 35d can calibrate not only the luminance calibration of capture unit 31 but also the geometric characteristic of capture unit 31. Specifically, display calibration device 30 transmits the image for calibration suitable for the calibration of the geometric characteristic of capture unit 31 to display device 20, thereby causing display device 20 to display the image for calibration. For example, the image for calibration used at this time is a test chart in which a geometrical figure used to calibrate an aberration of capture unit 31 is drawn.

Capture unit 31 captures the image for calibration displayed on display device 20. Imaging calibrator 35d corrects a distortion coefficient of capture unit 31 such that the geometric figure indicated by the image for calibration obtained by capture unit 31 coincides with the geometric figure indicated by the image for calibration transmitted to display device 20, thereby correcting the geometric characteristic of capture unit 31.

In this way, the imaging calibrator 35d can calibrate not only the luminance calibration of capture unit 31 but also the geometric characteristic of the capture unit 31. That is, capture unit 31 captures the image for calibration, which is displayed on display device 20 and used to calibrate capture unit 31. Imaging calibrator 35d calibrates the geometric characteristic of capture unit 31 using the image for calibration captured by capture unit 31.

Consequently, the geometric characteristic of capture unit 31 of display calibration device 30 can be calibrated by capturing the image for calibration displayed on display device 20, and the calibration of the luminance unevenness for display device 20 by display calibration device 30 is secured with high accuracy.

As described above, display calibration device 30, display calibration system 10, the method for calibrating display device 20, and display device 20 of the present disclosure are described based on the exemplary embodiment. However, the present disclosure is not limited to the exemplary embodiment. It is understood that various modifications to the exemplary embodiment that are conceived by those skilled in the art, and other exemplary embodiments obtained by a combination of components of the exemplary embodiment are also included within the scope of the present disclosure without departing from the scope of the present disclosure.

For example, in the exemplary embodiment, display calibration device 30 is the portable information terminal in which the camera such as a smartphone and a tablet terminal is incorporated. However, the present disclosure is not limited to this configuration, and display calibration device 30 may be a stationary type device as long as capture unit 31, communicator 34, and controller 35 are integrated. When capture unit 31, communicator 34, and controller 35 are integrated, the display characteristic of display device 20 can be calibrated at lower cost and fewer man-hours than before.

In the exemplary embodiment, the luminance calibration and the calibration of the luminance unevenness are performed by display calibration device 30. However, it is not always necessary to perform the luminance calibration and the calibration of the luminance unevenness. One of the luminance calibration and the calibration of the luminance unevenness may be performed.

In the exemplary embodiment, display calibration device 30 transmits, to display device 20, image for correction 11 to be displayed on display device 20. However, this transmission is not necessarily required. For example, display device 20 may display the image for correction previously held in display device 20, the image for correction read from an auxiliary storage device such as a USB memory, or the image for correction acquired from an external device through the Internet or the like. This is because display calibration device 30 can perform the calibration without previously holding the image for correction when the luminance unevenness or the like is calibrated.

In the exemplary embodiment, calibration jigs 40a and 40b and luminance meter 46 are provided as the accessory of display calibration device 30. Alternatively, calibration jigs 40a and 40b and luminance meter 46 may be devices that are independently distributed.

In the exemplary embodiment, controller 35 of display calibration device 30 includes calculating unit 35a, transmission unit 35b, correction image instruction unit 35c, imaging calibrator 35d, foreign matter detector 35e, and imaging controller 35f. However, it is not necessary for controller 35 to include all of these components. Correction image instruction unit 35c, imaging calibrator 35d, foreign matter detector 35e, and imaging controller 35f may be implemented by an application added as an option as necessary.

In the exemplary embodiment, storage 25 of display device 20 includes first storage 25a that stores previously-provided correction data 12a and second storage 25b that stores correction data 12b transmitted from display calibration device 30. Alternatively, storage 25 may further include a storage dedicated for backup and a storage that holds the image for correction and the image for calibration.

What is claimed is:

1. A display calibration device that calibrates a display characteristic of a display device, the display calibration device comprising:
a capture unit that captures an image displayed on the display device;
a communicator that communicates with the display device; and
a controller that controls the capture unit and the communicator,
wherein the controller includes:
an calculating unit that generates correction data used to correct the display characteristic by performing arithmetic operation on the image captured by the capture unit; and
a transmission unit that transmits the correction data generated by the calculating unit to the display device through the communicator, and
the capture unit, the communicator, and the controller are integrated.

2. The display calibration device according to claim 1, wherein the display calibration device is a portable information terminal.

3. The display calibration device according to claim 1, wherein the calculating unit generates the correction data by performing arithmetic operation on luminance at at least one representative point of the image captured by the capture unit using a reference value of the luminance at the representative point.

4. The display calibration device according to claim 1, wherein the calculating unit generates the correction data by performing arithmetic operation to calculate spatial luminance unevenness on the image captured by the capture unit.

5. The display calibration device according to claim 1, further comprising a correction image storage in which an image for correction is stored,
wherein the controller further includes a correction image instruction unit that transmits the image for correction stored in the correction image storage to the display device through the communicator and causes the display device to display the image for correction, and
the capture unit captures the image for correction displayed on the display device.

6. The display calibration device according to claim 5, wherein the calculating unit generates the correction data by performing arithmetic operation on luminance at at least one representative point of the image for correction captured by the capture unit using as a reference value luminance corresponding to the representative point of the image for correction stored in the correction image storage.

7. The display calibration device according to claim 1, further comprising a calibration jig that calibrates the capture unit,
wherein the calibration jig includes:
a light source; and
a positioning unit that positions the capture unit with respect to the light source.

8. The display calibration device according to claim 7, wherein
the calibration jig further includes a casing in which the light source and the capture unit are accommodated, and
the positioning unit is a positioning guide that fixes the capture unit into the casing.

9. The display calibration device according to claim 7, wherein the positioning unit is an attachment that is detachably attached to the capture unit.

10. The display calibration device according to claim 1, further comprising, as an accessory, a camera that captures the image displayed on the display device or a luminance meter that measures luminance of the image displayed on the display device,
wherein the controller further includes an imaging calibrator that acquires data from the accessory through the communicator and calibrates the capture unit using the acquired data.

11. The display calibration device according to claim 1, wherein
the capture unit captures a image for calibration displayed on the display device, the image for calibration being used to calibrate the capture unit, and
the controller further includes an imaging calibrator that calibrates a geometric characteristic of the capture unit using the image for calibration captured by the capture unit.

12. The display calibration device according to claim 1, wherein
the display device switches and displays a plurality of different images,
the capture unit captures the plurality of images displayed on the display device, and
the controller further includes a foreign matter detector that detects, from the plurality of images captured by the capture unit, a foreign matter adhered to a screen of the display device or the capture unit by determining whether an identical display object exists at a common position in the plurality of images, and presents the adhesion of the foreign matter to a user.

13. The display calibration device according to claim 1, wherein
the controller further includes an imaging controller that controls the capture unit such that the image displayed on the display device is captured from a plurality of viewpoints, and
the calculating unit synthesizes a plurality of images captured from the plurality of viewpoints by the capture unit, and generates the correction data by performing the arithmetic operation on the image obtained by the synthesis.

14. The display calibration device according to claim 1, further comprising an initial image storage in which an initial image indicating a spatial distribution of luminance of the display device is stored,
wherein the calculating unit generates the correction data by calculating spatial luminance unevenness of the image captured by the capture unit based on the initial image stored in the initial image storage.

15. A display calibration system comprising:
a display device; and
the display calibration device according to claim 1 that calibrates a display characteristic of the display device.

16. A display device comprising:
a communicator that communicates with the display calibration device according to claim 1;
a video signal generator that acquires an image transmitted from the display calibration device through the communicator and generates a video signal indicating the acquired image;
a video signal processor that includes a storage that obtains correction data transmitted from the display calibration device through the communicator and stores the correction data, the video signal processor correcting the video signal generated by the video signal generator using the correction data stored in the storage; and
a display panel that displays the video signal corrected by the video signal processor.

17. The display device according to claim 16, wherein the storage has a storage capacity in which at least two pieces of correction data indicating different corrections are stored.

18. The display device according to claim 17, wherein the storage includes a first storage in which previously-provided correction data is stored and a second storage in which correction data transmitted from the display calibration device is stored.

19. The display device according to claim 17, wherein
the video signal processor outputs the video signal generated by the video signal generator without correcting the video signal using the correction data stored in the storage, and
the display panel displays the video signal that is output from the video signal processor without performing the correction.
